(19) United States
(12) Patent Application Publication
(10) Pub. No.: US 2022/0009044 A1
(43) Pub. Date: Jan. 13, 2022

(54) METHOD FOR MANUFACTURING GEAR

(71) Applicant: TOYOTA JIDOSHA KABUSHIKI KAISHA, Toyota-shi (JP)

(72) Inventor: Noriaki YOSHIHIRO, Toyota-shi (JP)

(73) Assignee: TOYOTA JIDOSHA KABUSHIKI KAISHA, Toyota-shi (JP)

(21) Appl. No.: 17/345,748

(22) Filed: Jun. 11, 2021

(30) Foreign Application Priority Data
Jul. 13, 2020 (JP) 2020-119938

(51) Int. Cl. B23P 15/14; F16H 55/08

(52) U.S. Cl. CPC B23P 15/14; F16H 55/0806

(57) ABSTRACT

A method for manufacturing a gear includes setting a function f(x) for forming a predetermined tooth profile in a gear, and forming a tooth root and tooth tip using function f(x). Function f(x) is defined so that: a surface shape of the tooth profile from the tooth root to tip has a vertex; a difference between a curvature radius of the surface shape at the tooth root and a radius of an arc or a radius of curvature of a parabola at the root is within a predetermined value; a difference between a curvature radius of the surface shape at the tooth tip and the arc radius or a curvature radius of the parabola at the tip is equal to or greater than a predetermined value; and the surface shape curvature radius at the tip becomes smaller than the arc radius or the parabola curvature radius at the tip.

### CROSS REFERENCE TO RELATED APPLICATIONS

This application is based upon and claims the benefit of priority from Japanese patent application No. 2020-119938, filed on Jul. 13, 2020, the disclosure of which is incorporated herein in its entirety by reference.

### BACKGROUND

The present disclosure relates to a method for manufacturing a gear.

Published Japanese Translation of PCT International Publication for Patent Application, No. 2014-519986 (Patent Literature 1) discloses a method for manufacturing a tooth part of a drive spindle for driving a roll of a rolling mill or the like. In the manufacturing method disclosed in Patent Literature 1, a step of processing the tooth root of the arched tooth part so that it is lowered and a step of processing the tooth tip thereof so that it is lowered are performed separately.

### SUMMARY

In Patent Literature 1, since the processing of a tooth part is divided into a plurality of steps, a precision error is more likely to occur than when the tooth part is processed in just one step. Meanwhile, forming a tooth profile by a quadratic function causes a problem that it is difficult to achieve both reduction of the risk of a collision of tooth tips and quietness.

The present disclosure has been made to solve the above-described problem and an object thereof is to provide a method for manufacturing a gear which is capable of reducing the risk of occurrence of a precision error in a tooth profile and achieving both reduction of the risk of a collision of tooth tips and quietness.

A first exemplary aspect is a method for manufacturing a gear, the method including: setting a function f(x) for forming a predetermined tooth profile in a gear, the function f(x) being defined so that: a surface shape of the tooth profile from a tooth root to a tooth tip has a vertex; a difference between a radius of curvature of the surface shape of the tooth profile at the tooth root and a radius of an arc or a radius of curvature of a parabola at the tooth root is within a predetermined value, the radius of the arc or the radius of curvature of the parabola at the tooth root being in contact with the vertex; a difference between a radius of curvature of the surface shape of the tooth profile at the tooth tip and the radius of the arc or a radius of curvature of the parabola at the tooth tip is equal to or greater than a predetermined value; and the radius of curvature of the surface shape of the tooth profile at the tooth tip becomes smaller than the radius of the arc or the radius of curvature of the parabola at the tooth tip; and forming the tooth root and the tooth tip by using the function f(x).

According to the present disclosure, it is possible to reduce the risk of occurrence of a precision error in a tooth profile and achieve both reduction of the risk of a collision of tooth tips and quietness.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a diagram showing a gear according to an embodiment;

FIG. 2 is a diagram showing an example of a function f(x) used to process a tooth profile in a method for manufacturing a gear according to the embodiment;

FIG. 3 is a diagram for explaining another example of the function f(x) used to process the tooth profile in the method for manufacturing a gear according to the embodiment;

FIG. 4 is a diagram for explaining a convergence calculation for obtaining a value a that satisfies g(a)=p for a function g(a);

FIG. 5 is a diagram showing a function used to correct a tooth profile according to a comparative example;

FIG. 6 is a diagram showing a function used to correct the tooth profile according to the comparative example; and

FIG. 7 is a diagram showing a function used to correct the tooth profile according to the comparative example.

### DESCRIPTION OF EMBODIMENTS

An embodiment according to the present disclosure will be described hereinafter with reference to the drawings. The components equivalent to each other are denoted by the same reference sign throughout the drawings, and redundant descriptions will be omitted.

The embodiment relates to a method for manufacturing a gear, the gear having a plurality of teeth and transmitting the rotational motion between two axes by engagement with teeth of a mating gear. FIG. 1 is a diagram showing structures of gears 10 and 20 according to the embodiment. In the example shown in FIG. 1, the gears 10 and 20 have substantially disk-like shapes and have a plurality of teeth 11 and 21 on the outer circumferential side thereof, respectively.

A side surface of the tooth 11 is a tooth flank 12, a part of the tooth 11 on the tip side thereof is a tooth tip 14, and a part of the tooth 11 on the side of a tooth groove formed between the teeth 11 adjacent to each other is a tooth root 15. FIG. 1 shows a state in which the gears 10 and 20 are engaged with each other at a position surrounded by a broken line circle.

When the shape of the tooth flank 12 of the gear 10 is designed, it is classified into the two shapes described below. The first shape is an involute curve, which is an ideal shape that achieves an ideal engagement when the gear is completely rigid and there is no assembly error. The tooth 11 having the tooth flank 12 having an involute curve is formed into a symmetrical standard gear tooth profile 13. The second shape is a corrected shape obtained by taking the quietness and the smoothness of engagement into consideration based on a shape error and an assembling error.

Normally, when the gears 10 and 20 are engaged with each other, the tooth tip and the side surface of a gear causes interference with a mating gear or puts high surface pressure on the mating gear, and thus wear occurs. For example, in a state in which the gears 10 and 20 are rotated at a high torque, when the gears 10 and 20 are engaged with each other, the respective teeth 11 and 21 are deformed by a load and hence a deflection occurs in a direction indicated by an arrow in FIG. 1. At this time, local wear occurs in the tooth width direction on the respective side surfaces of the teeth 11 and 21.

Further, when the tooth flanks of the teeth that are to be engaged with each other next are not in the phase in which they are originally engaged, the tooth tip of the gear 20, for example, interferes with the tooth root of the gear 10 or puts a high surface pressure (contact stress) on the tooth root of the gear 10, and local wear of the teeth results. Engagement in which wear has occurred impairs quietness and the lifetime of the tooth tip and, in the worst case, a risk of causing destruction of the tooth tip arises.

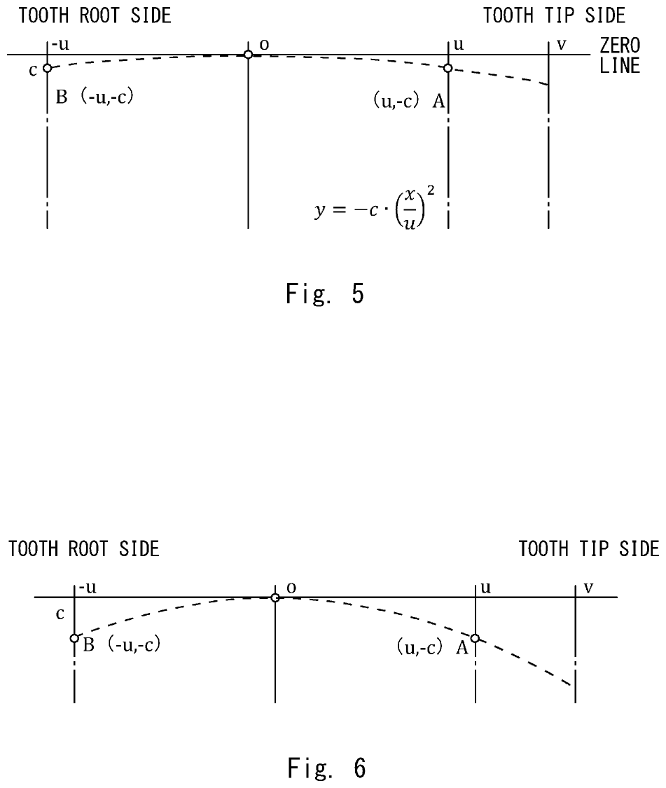

As measures for overcoming the above problem, for example, a tooth tip relief shape (a tooth tip relief) obtained by correcting the tooth profile of a standard gear can be used. The actual shape of the tooth profile is a geometric shape formed by combining an ideal shape and a corrected shape, and the corrected shape will be described below. FIGS. 5, 6, and 7 show functions used to correct the tooth profile 13 of the gear according to the comparative example. In each of FIGS. 5 to 7, the left side thereof is the tooth root side and the right side thereof is the tooth tip side.

In each of FIGS. 5 to 7, the horizontal axis indicates a length of the line of action of the gear. In this example, the length of the line of action is equal to a tooth height h shown in FIG. 1. Further, the vertical axis indicates the position of the surface of the tooth flank. The zero line of the vertical axis is an ideal shape of the surface shape of the tooth profile, and by using this zero line as a reference, processing of scraping the surface from the standard tooth profile as the surface shape of the tooth profile goes toward the minus side is performed.

As a corrected shape of the tooth shape which takes quietness into careful consideration, a parabolic shape, an arc shape, and the like can be used. In FIGS. 5 and 6, an example of a parabolic shape is shown, and the parabola is expressed by the following Expression (1).

$$y = - c \cdot {( \frac{x}{u} )}^{2} \qquad ( 1 )$$

The surface shape of the tooth profile from the tooth root to the tooth tip has a vertex. A point of contact between the vertex and an ideal shape is defined as O. Further, v is an end of the tooth tip side, and −u(v>u) is an end of the tooth root side. Further, u is located between the vertex and the tooth tip. Further, c is an arbitrary proportional constant. By changing c, it is possible to change the shape of the tooth profile. Further, c shown in FIG. 5 is smaller than c shown in FIG. 6.

As shown in FIG. 5, although a tooth profile having a high level of quietness can be designed by reducing c, a risk of interference of the tooth tips is high. On the other hand, as shown in FIG. 6, although the risk of interference of the tooth tips can be reduced by increasing c, the level of the quietness is deteriorated due to a large deviation at the center of the tooth profile.

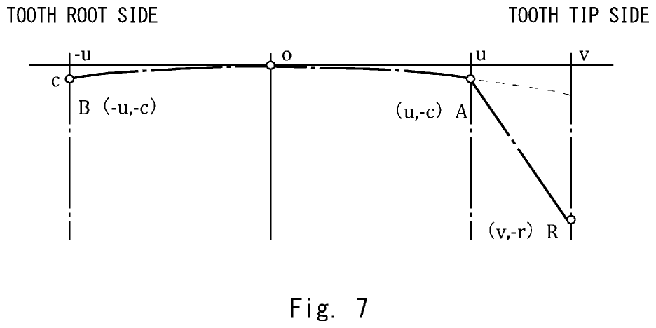

In the example shown in FIG. 7, the tooth profile is divided into two regions to form a parabolic shape and a tooth tip relief shape which take quietness and interference of the tooth tips into consideration. In FIG. 7, it can be expected that the parabolic shape of from A to B will achieve quietness and the tooth tip relief shape of from A to R will reduce a risk of interference of the tooth tips. However, in the shape of the tooth profile of FIG. 7, a point of discontinuity occurs at the point A. In this case, when the tooth flank is subjected to NC (numerical control) machining, it is necessary to express two regions by two curves different from each other, and thus design, analysis, and manufacturing becomes complicated. Further, when the parabolic shape and the tooth tip relief shape are processed by dividing the processing step into two steps, there is a problem that the process performed at the point A is difficult because of occurrence of a precision error, and the like.

To address the above problem, the inventor of the present disclosure has conceived the following manufacturing method in which the tooth root and the tooth tip are processed in one step. A method for manufacturing a gear according to the embodiment includes: setting a function f(x) for forming a predetermined tooth profile in a gear, the function f(x) being defined so that: a surface shape of the tooth profile from a tooth root to a tooth tip has a vertex; a difference between a radius of curvature of the surface shape of the tooth profile at the tooth root and a radius of an arc or a radius of curvature of a parabola at the tooth root is within a predetermined value, the radius of the arc or the radius of curvature of the parabola at the tooth root being in contact with the vertex; a difference between a radius of curvature of the surface shape of the tooth profile at the tooth tip and the radius of the arc or a radius of curvature of the parabola at the tooth tip is equal to or greater than a predetermined value; and the radius of curvature of the surface shape of the tooth profile at the tooth tip becomes smaller than the radius of the arc or the radius of curvature of the parabola at the tooth tip; and forming the tooth root and the tooth tip by using the function f(x).

As described above, by performing machining by numerical control using the one aforementioned function f(x), it is possible to reduce the risk of occurrence of a precision error in a tooth profile and achieve both reduction of the risk of a collision of tooth tips and quietness. The above function f(x) is one general-purpose expression in which the surface shape of the tooth profile from the tooth root to the tooth tip becomes continuous and smooth. An example of the function f(x) will be described below.

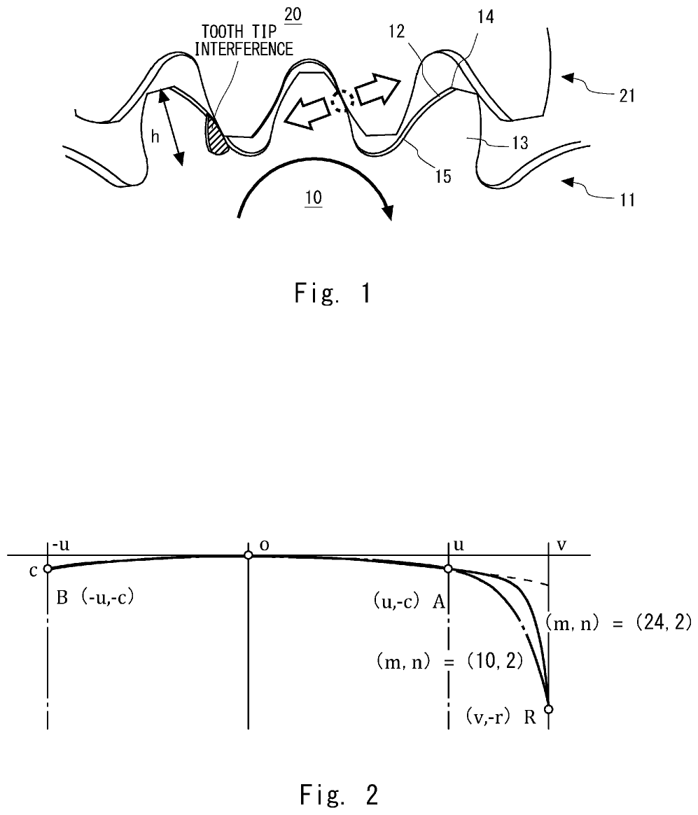

FIG. 2 is a diagram showing the example of the function f(x) used to process a tooth profile in the method for manufacturing a gear according to the embodiment. The function f(x) shown in FIG. 2 is expressed by the following Expression (2). Expression (2) is an even function polynomial.

f(x)=−ax^{m}−bxⁿ (2)

where a>0, b>0, and m>n, and m and n are positive even numbers.

As shown in FIG. 2, B(−u,−c), A(u,−c), and R(v,−r) are set from the tooth root to the tooth tip. When the points A and R are substituted into Expression (2), the following expressions hold.

f(v)=−r

f(u)=−c

The following Expressions (3) and (4) are obtained from the above expressions.

av^{m}+bvⁿ=r (3)

au^{m}+buⁿ=c (4)

When H is set to H=v^{m}uⁿ−vⁿu^{m}, the following Expression (5) is obtained from Expressions (3) and (4).

$$( \begin{matrix}a \\ b\end{matrix} ) = \frac{1}{H} \cdot ( \begin{matrix}{u}^{n} & - {v}^{n} \\ - {u}^{m} & {v}^{m}\end{matrix} ) ( \begin{matrix}r \\ c\end{matrix} ) \qquad ( 5 )$$

where r/c>(v/u)ⁿ is required.

In FIG. 2, for example, (m, n)=(24, 2) is indicated by a solid line, and (m, n)=(10, 2) is indicated by an alternate long and short dashed line. Further, for comparison with the former, a parabola having the point O as a vertex is indicated by a broken line. The surface shape of the tooth profile indicated by Expression (2) and the parabola indicated by the broken line are in contact with each other at the vertex (the point O). As can be seen from FIG. 2, when Expression (2) is used, the surface shape (from B to R via O and A) of the tooth profile from the tooth root to the tooth tip becomes continuous and smooth.

Further, on the tooth root side, the radius of curvature of the surface shape of the tooth profile and the radius of curvature of the parabola are each within a predetermined value. Further, on the tooth tip side, the radius of curvature of the surface shape of the tooth profile and the radius of curvature of the parabola are each equal to or greater than a predetermined value. Further, on the tooth tip side, the radius of curvature of the surface shape of the tooth profile becomes smaller than the radius of curvature of the parabola. For example, when n=2, it is likely that the shape of from B to A via O is less deviated from the parabolic shape. Further, when m is large, the relief is likely to be closer to the tooth tip.

In this way, it is possible to achieve both reduction of the risk of a collision of tooth tips of a gear and quietness. Further, by performing NC machining using the above function f(x), it is possible to process the tooth root and the tooth tip in one step. Thus, it is possible to reduce a risk of occurrence of a precision error in the tooth profile.

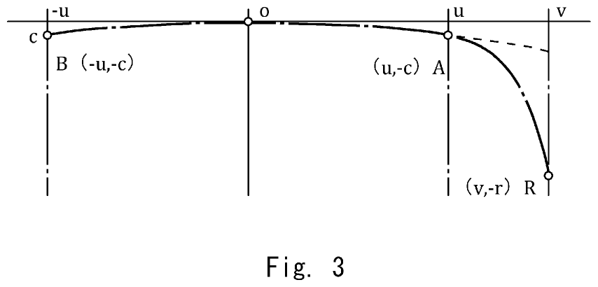

FIG. 3 is a diagram for explaining another example of the function f(x) used to process a tooth profile in the method for manufacturing a gear according to the embodiment. The function f(x) shown in FIG. 2 is expressed by the following Expression (6). Expression (6) is an even function exponential function expression.

$$f ( x ) = - c \cdot \frac{{a}^{{( \frac{x}{u} )}^{2}} - 1}{a - 1} \qquad ( 6 )$$

where a is determined from c, r, u, and v, and is equal to or greater than one.

When the point A (u,−c) and the point R (v,−r) are substituted into Expression (6), the following Expressions (7) and (8) are obtained.

$$\begin{matrix}f ( u ) = - c \cdot \frac{{a}^{{( \frac{u}{u} )}^{2}} - 1}{a - 1} = - c & ( 7 ) \\ f ( v ) = - c \cdot \frac{{a}^{{( \frac{v}{u} )}^{2}} - 1}{a - 1} = - r & ( 8 )\end{matrix}$$

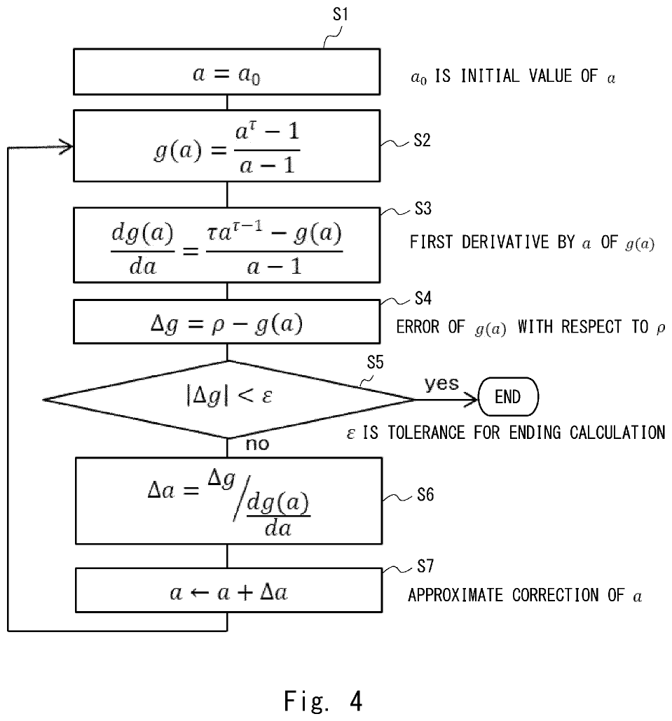

Here, τ=(v/u)² and ρ=r/c, and the convergence calculation shown in FIG. 4 is performed so that the following expression holds.

$$g ( a ) = \frac{{a}^{τ} - 1}{a - 1} = ρ$$

FIG. 4 is a diagram for explaining the convergence calculation for obtaining a value a that satisfies g(a)=ρ for a function g(a).

The initial value of a is set to a₀ (S1). Then a first derivative by a of g(a) shown in S2 is obtained (S3). Then an error Δg of g(a) with respect to ρ is obtained (S4). If the absolute value of Δg is smaller than a tolerance ε (yes in S5), the calculation ends. On the other hand, if the absolute value of Δg is equal to or greater than the tolerance ε (no in S5), Aa shown in S6 is added to a, to thereby perform approximate correction on a (S7), and the calculation is repeated for the approximate value until the absolute value of the error Δg becomes smaller than the tolerance ϵ.

By using the above function f(x), it is possible to design a tooth profile that can achieve both quietness and durability by one general-purpose expression. Thus, when the surface of the tooth 11 is subjected to NC machining, the tooth flank can be processed so that it becomes continuous and smooth in one step. Since the point A in the tooth profile is smooth, the stress applied to the tooth 11 is further reduced, and thus a gear having resistant to wear can be obtained.

As described above, according to the embodiment, it is possible to set the function f(x) in which the shape of the tooth root becomes a shape similar to the parabolic shape represented by a quadratic function and the shape of the tooth tip becomes a more curved shape than that of the parabolic shape. By performing correction processing of the tooth profile using the above function f(x), it is possible to form the tooth tip that can achieve both reduction of the risk of a collision of the tooth tips and quietness by one function. Thus, it is possible to reduce the number of processing steps, facilitate processing, and prevent errors from occurring.

Note that the present disclosure is not limited to the above-described embodiment and may be modified as appropriate without departing from the spirit of the present disclosure. In the above-described example, although the function f(x) according to the embodiment is compared with a parabola passing through the same vertex, it may instead be compared with an arc passing through the same vertex.

Further, the above-described embodiment provides an example in which in NC machining, operations of a grinding tool, such as a grinding wheel, and a workpiece which is to be a gear are controlled to thereby form a predetermined tooth profile, but the present disclosure is not limited thereto. For example, in a case in which the tooth flank of a workpiece which is to be a gear is grounded with a grinding wheel to thereby finish the predetermined tooth shape, when the grinding wheel is dressed by using a dresser, the grinding wheel can be dressed into a shape corresponding to the predetermined tooth shape by using the function f(x) described above.

Further, when a gear is molded by rolling a workpiece using a rolling die, the rolling die may be formed into a transfer shape corresponding to a predetermined tooth shape by using the function f(x) described above. In a rolling molding, for example, a workpiece is held between a pair of rolling dies rotating in the same direction and the tooth part of the rolling die is transferred as a groove to the outer peripheral surface of the workpiece, whereby it is possible to manufacture a gear having a tooth profile of a predetermined shape.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method for manufacturing a gear, the method comprising:
setting a function f(x) for forming a predetermined tooth profile in a gear, the function f(x) being defined so that:
a surface shape of the tooth profile from a tooth root to a tooth tip has a vertex;
a difference between a radius of curvature of the surface shape of the tooth profile at the tooth root and a radius of an arc or a radius of curvature of a parabola at the tooth root is within a predetermined value, the radius of the arc or the radius of curvature of the parabola at the tooth root being in contact with the vertex;
a difference between a radius of curvature of the surface shape of the tooth profile at the tooth tip and the radius of the arc or a radius of curvature of the parabola at the tooth tip is equal to or greater than a predetermined value; and
the radius of curvature of the surface shape of the tooth profile at the tooth tip becomes smaller than the radius of the arc or the radius of curvature of the parabola at the tooth tip; and
forming the tooth root and the tooth tip by using the function f(x).

2. The method for manufacturing a gear according to claim 1, wherein the function f(x) is expressed by an expression:
f(x)=−ax^{m}−bxⁿ
where a>0, b>0, and m>n, and m and n are positive even numbers.

3. The method for manufacturing a gear according to claim 2, wherein the surface shape of the tooth profile is determined by substituting a value of a position (−u,−c) of an end of the tooth root, a value of a position (v,−r) of an end of the tooth tip, and a value of a position (u,−c) between the vertex and the tooth tip into the function f(x) and thereby obtaining values m and n that satisfy r/c>(v/u)ⁿ, the position (−u,−c), the position (v,−r), and the position (u,−c) being set using a point of contact between the vertex and an ideal shape as a point of origin.

4. The method for manufacturing a gear according to claim 1, wherein the function f(x) is expressed by an expression:
$$f ( x ) = - c \cdot \frac{{a}^{{( \frac{x}{u} )}^{2}} - 1}{a - 1}$$
where a value a is determined from the position (−u,−c) of the end of the tooth root, the position (v,−r) of the end of the tooth tip, and the position (u,−c) between the vertex and the tooth tip, the value a being equal to or greater than one, the position (−u,−c), the position (v,−r), and the position (u,−c) being set using the point of contact between the vertex and the ideal shape as the point of origin.

5. The method for manufacturing a gear according to claim 4, wherein the surface shape of the tooth profile is determined by obtaining, using convergence calculation, the value a from the expression obtained by substituting the position (−u,−c) of the end of the tooth root, the position (v,−r) of the end of the tooth tip, and the position (u,−c) between the vertex and the tooth tip into the function f(x).
